(19) United States
(12) Patent Application Publication
(10) Pub. No.: US 2014/0229853 A1
(43) Pub. Date: Aug. 14, 2014

(54) Methods and System for an Advanced Electronic Mail System Based on Time Scheduling and Message Prioritizing Software Device

(71) Applicant: Jeong Yearn Cho, Santa Clara, CA (US)

(72) Inventor: Jeong Yearn Cho, Santa Clara, CA (US)

(21) Appl. No.: 13/762,488

(22) Filed: Feb. 8, 2013

(51) Int. Cl. G06F 3/048

(52) U.S. Cl. CPC G06F 3/048
USPC 715/752

(57) ABSTRACT

A Time Scheduling and or Message Prioritizing Software device presents to a user one or more graphics representative of a Time Scheduling and or Message Prioritizing options. The one or more graphics are located within an email composing page of a browser or application based email program. A user can select to use either one of, or both Time Scheduling and Message Prioritizing options in order to send emails to a second user in a user-desirable time and date; and to present a second user with due dates for important messages and help highlight valuable prioritized messages.

### FIELD OF THE INVENTION

The present invention relates to an electronic mailing system and method of use and more particularly, an advanced electronic mailing system that helps a user prioritize and manage a temporal aspect of outgoing and incoming mail reception so that user has a more satisfying email experience.

### BACKGROUND OF THE INVENTION

Since the advent of modern computing, electronic communication between two or more parties has played an integral role in the personal appeal and rapid extension of the computer revolution known as the internet; other networking architectures have likewise followed suit and adopted the store and forward email model proposed so long ago. As desktop application software became ubiquitous, it is almost a given that users will either use a standalone email application or browser based email application to communicate with one another. Thus, email is a standard faculty of any modern computer system and all other message transmitting applications including but not limited to mobile applications that facilitates interfacing with others on the web, or any communication network.

Email is now commonly used for communicating for personal and business purposes as well as researching information on products, promotions and services. However, unfortunate side effects are precipitated in every leap forward. With regards to the innovation known as email, users have been inundated with unwanted mail messages that block easy access to desirable messages from colleagues, friends and family members. This unwanted email is more commonly known as SPAM and it is a veritable plague that afflicts the accounts of most email users. Additionally, there are those email messages termed herein as ‘noise’ emails that fill an inbox that although from a friend, colleague, family member or trusted source are not considered critical or important enough to be read as soon as possible. Both SPAM and the extra ‘noise’ emails that come from those that are known users are problems that need to be dealt with if an email user is able to utilize his email system effectively.

To more fully understand how to do so it is instructive to learn about the operation of the typical email system. The email account of a typical user receives mail throughout the day and night and is generally accessible twenty four hours a day. Upon the opening of his or her email system, a user has to search through a list of the many new emails that have arrived since he or she previously opened his email software. Various techniques, like the highlighting of the email messages or the underlining of messages, visually indicate those messages that have not been read yet on the screen. As the amount of SPAM and ‘noise’ email enters the list sometimes it may happen that very important emails are not found easily unless a user searches thoroughly therein. As the undesirable messages grow exponentially, important messages have the tendency to be hidden and even buried somewhere amongst the nuisance emails; another difficulty arises in that the email program can sometimes flag valuable messages as spam and then places them into a spam filter email box.

The result of an important message not being readily available can cause havoc with business, personal relationships and more. A slow reply to an important message can cause a missed due date to make a payment or to send important documents for things such as a college admission, a job application, or the missing of important business deals. Even though a user reads the email that requires a confirmation and/or reply by the sender, there is the possibility of missing the due date, or that he or she might even forget to reply back; as discussed previously, the main culprit for this is because of the enormous number of emails arriving daily. Thus, it is almost impossible for a user to memorize all due dates of the various important emails. As a cascading effect of the SPAM and ‘Noise’ problem, sometimes even though the receivers sends a reply back right away, it may happen that the originating party misses it at their end for similar reasons, i.e., because they also have received tons of emails everyday. A request for retransmission is then sent by the originating user to the recipient so as to resend the reply; this phenomenon is quite common amongst millions of users causing enormous strain on productivity and computer resources.

Thus, there needs to be some solution that overcomes the aforementioned difficulties and that permits a more user friendly experience without encumbering the user with innumerable unimportant emails.

### SUMMARY OF THE INVENTION

The present invention overcomes the deficiencies of the known art and the problems that remain unsolved by providing a method of Time Scheduling and or Message Prioritizing as described variously below.

A method of time scheduling email messages on a computer device is comprising the steps of starting an email program having an email composing page and presenting a user with a graphical user interface having an email time scheduling option associated with the email composing page. Then the process continues by opening a time scheduling menu for user interaction and receiving user response indicating user selected preferences of the time scheduling menu. Next, placing emails in a queue for time and or date based transmission followed by creating a queue record of emails that have been queued. Then, displaying a graphic representative of the queue record to the user. Then transmitting a queued email message to another user via a network. The time scheduling menu has user interactive graphic selection items chosen from the group comprising: year, month, date, hour, minute, time zone and all combinations of the foregoing. The graphic representative of the queue record has graphical items chosen from the group comprising: scheduled time, message title, status, checkbox, edit/cancel graphic, reschedule interactive graphic and all combinations of the foregoing.

A method of prioritizing email messages on a computer device is comprising starting an email program having an email composing page and presenting a first user with a graphical user interface having an email message prioritization option associated with the email composing page. Then the process continues by opening a message prioritizing menu for user interaction and receiving the first user's response indicating the first user's selected preferences of the message prioritizing menu. Then the process continues by transmitting an email message to a second user via a network and displaying an incoming email message box at the second user's computer. The process continues by checking a prioritizing flag and if set then the incoming message is prioritized so displaying an incoming email message priority box at the second user's computer otherwise go to a normal email routine. Next, the process determines if the second user wants to reset the prioritizing flag and if not then the email message is kept as prioritize otherwise the prioritizing flag is reset and the email message is placed in an ordinary place in the incoming email box. Then the process continues by transmitting a reply from the second user across a network to the first user after the second user has interacted with the incoming email box to create a reply to the first user and placing the email message in an ordinary place in the incoming email box. The message prioritizing menu has user interactive graphic selection items chosen from the group comprising: due year, due month, due day, due hour, due minute, set priority graphic, set due graphic and all combinations of the foregoing. The incoming email message box has graphical items chosen from the group comprising: checkbox, priority flag, due date, sender, message subject, priority delete graphic, keep priority graphic and all combinations of the foregoing.

A method of time scheduling and message prioritization of email messages on a computer device includes starting an email program having an email composing page and presenting a user with a graphical user interface having an email time scheduling optional graphical interactive and an email prioritization optional graphical interactive associated with the email composing page.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate the various novelties taught herein; the various diagrams teach conceptual routine flow and design details that are described later. However, it should be appreciated that the conceptual design details as described in the drawings below does not include all variations of the invention that can be practiced; as can be appreciated numerous changes could be made without departing from the spirit and scope of the invention herein.

FIG. 1 presents a flow diagram of Time Scheduling Routine with various features that are to be discussed in an embodiment; this flow diagram also includes a simplified Message Prioritizing Routine that is combined and used with the Time Scheduling Routine when it is operated as a mixed mode if it is selected by a user; this routine also includes a manual override operation by the user in order to reschedule and cancel the schedule;

FIG. 2 presents a sample email composing page GUI with special menu buttons in this embodiment for a Time Scheduling menu popup that is activated to permit entry of user Time Scheduling information;

FIG. 3 presents an embodiment of a GUI Time-scheduled Outgoing Email Queue that lets the user know what scheduled message has been already sent, and what is still in the queue waiting for the date and time to be sent out;

FIG. 4 presents an embodiment of a Message Prioritizing Routine at the originating end that also includes a simplified Time Scheduling Routine that is combined and used with Message Prioritizing Routine when it is operated in a mixed mode if it is selected by the user;

FIG. 5 presents a sample email composing page GUI with special menu buttons in this embodiment for a Message Prioritizing menu popup that is activated to permit entry of user Message Prioritizing information;

FIG. 6 presents an embodiment of a GUI Recipient Incoming Email Box from which the user can recognize which incoming emails are important emails and/or when is the due date/time that were marked by the sender as the prioritized and/or the due-dated;

FIG. 7 presents a flow diagram of Message Prioritizing Routine at the receiving end; this flow diagram also includes a simplified Time Scheduling Routine that is combined and used with Message Prioritizing Routine when it is operated as a mixed mode if it is selected by a user. This routine also includes Message Prioritizing Routine that can be activated independently by the recipient (the second user).

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in the particular Figure being described or referenced. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

To overcome the deficiencies described previously, the instant novelties teach a method and system to eliminate these problems and/or inconveniences by adopting the following two extra user-convenient features onto currently available email systems. These are namely, a Time Scheduling Software Device and a Message Prioritizing Software Device.

### Time Scheduling Software Device

This concept was developed from the following real world example. Suppose that someone receives an email during weekdays and this email requires a reply back to a sender before noon the next Monday. The due date is in approximately 4-5 days but the recipient wants to reply back right away in order not to miss the due date and/or even not to forget to reply back. However, the recipient is also concerned about their early reply being buried amongst tons of emails at the receiving end; therefore, the receiving party may not read the email in time.

This worry is eliminated if they use a Time Scheduling Method and System when writing and sending the reply email. Once completing the reply, they set the time and date to send out the replying email. An email system using this Time Scheduling Routine puts the already written replying email in a dedicated Time-scheduled Outgoing Email Queue and keeps it until the time and date that the user indicated to send it out; it then sends it out at the designated time to the recipient. Users can double check this Record of Time-scheduled Outgoing Email Queue that shows whether mails were sent out at the scheduled time or still is in a queue waiting for the sending time and date. The system permits users to change the scheduled time, if needed, from the Record of Time-scheduled Outgoing Email Queue.

For example, if someone in the example above has set the mailing time to be at 7:50 am on the next Monday, then a time scheduling routine keeps the pre-written replying email in a queue and sends it out at 7:50 am just before when the recipient arrives at his or her office at 8:00 am on Monday. Thus, the recipient receives the important replying email just on time without trying to locate the email buried among a plethora of normal emails that have also arrived during the weekend. In this fashion, even though the replying party send the email several days earlier it still arrives at a optimum moment for the recipient's easy visualization.

Another aspect of the Time Scheduling Routine that proves to be useful is that the origination of emails can likewise use a similar system and method to facilitate the easy review of an important email. An originating email can be created using the Time Scheduling Routine anytime during the week but its transmission is optimized for the end user to easily and rapidly find this important message. As in the recipient reply email described above, the origination email is transmitted at the time and date that the user of the originating email wants to send it out. He or she does not have to worry about when this important email will arrive and how it will be read as it will arrive in a preferred time slot for easy review at the receiving end at preferred time.

Another aspect of the instant embodiment that is highly important is a time scheduling concept. This Time Scheduling feature will be useful between users that are located in different time zones. To ensure that the messages are transmitted and received at correct times the system and method of the instant embodiment compensates for differing time zones when presenting times to the user that is preparing to transmit an email. In this manner, the time/date scheduling feature facilitates accurate message time arrival thereby ensuring that the sender does not send a message that arrives at an incorrect time.

### Message Prioritizing Software Device

Message Prioritizing is a method and system to prioritize outgoing emails at the sending end and incoming emails at the receiving end; this makes important and/or urgent emails visible on a top portion of incoming mail box all the time, no matter when the emails have been sent and/or received. In this way, the important and/or urgent received emails are visually prioritized on the top and are not placed down in the email queue. If this system and method were not used then the important urgent messages would be lost in the numerous incoming mails that fill the screen and would soon be lost as they scroll down the screen and on to the second third and other pages of the queue. Therefore, users of the instant embodiment are able to easily see important and/or urgent incoming prioritized emails that have arrived at the top of queue.

### Two Method to Prioritize Emails

Sending/Originating Emails:

When a user wants to have an important message arrived as a prioritized email at the recipient he or she specifies that the outgoing emails is an ‘important prioritized email.’ Additionally, the originating user provides the recipient with an alert that requires that they reply in a specified time period. This alert demands an exact due date and time and/or confirmation requesting a response back from the recipient in a specified time period if needed. This procedure runs the Message Prioritizing Routine of the email system and sets a priority flag as well as sends the flagged email having the due date and time if these features have been required.

This Message Prioritizing Routine is operable on the same homogeneous email system with this prioritizing routine implemented at both originating and receiving parties. The meaning of the term homogeneous email system is that both originating and receiving parties have the same email system provided by the same commercial email providers. In the event that the email system at the receiving end does not have these features, the email system operates just as a conventional email system without any ‘prioritizing’ of incoming emails; thus, the conventional system would treat these messages as normal emails. Therefore, if the Message Prioritizing feature is not wanted in a heterogenous email system programmers can write code that skips the process of the prioritizing flag detection; thus, this avoids an email error alert due to reception of this extra information.

It should be realized that the prioritizing flag is just an one bit flag that is set and reset and is assigned within an email head. The concept is extensible to two heterogeneous email systems; to accomplish this feature between heterogeneous email systems that are developed by different email providers, the standardization of the prioritizing bit assignment must be arranged in advance. If the due date/time and confirmation request are also used, allocation of this information in the email header should be standardized beforehand between the email providers. However, this extra information assignment may become the de facto standard as more and more email providers adopt these concepts and popularize them amongst email users.

Reception of Emails:

At the receiving end, if the email system detects that the prioritizing bit is set, then the email system runs the Message Prioritizing Routine. Once the email system detects that the prioritizing flag is set the email system lists this email at the top portion of the incoming mail queue and keeps it in this high priority position until the recipients read the message and reply back. Once a reply is sent back, the prioritizing flag is reset and the email is placed in the ordinary date order of normal emails. Alternatively, it may be kept in the high priority top position until they receive a confirmation from other party.

Once the prioritizing bit is set on the incoming email, then the receiving end treats it as an important, and/or urgent email and does not place it in the spam mail box. However, it is possible that a spam email sender can use this feature in a malicious way defeating the purpose for the system. To avoid this problem, for any junk/spam emails with the prioritizing flag set, recipients can forcedly reset this feature, and then this incoming email is treated as a normal email or deleted permanently by recipients from the incoming box. When the due date/time is specified and delivered to the recipients, the Message Prioritizing Routine at the receiving end presents them in the email list so that the due date/time is visible to the user along with priority status.

Another aspect of the instant embodiment permits the user to use this useful feature independently. For example, when email users receive an email that they think it is important they might want to prioritize this email themselves. In the event that there is a future due date in several days hence then they may choose to prioritize the message to keep it visible so as to ensure that they reply before the due date. This enables the user to remember the due date until they finally reply back. This routine also has the capability to alert users about how many days or hours are left before the due date.

At the receiving end this procedure runs independently from the originating part; therefore, users can prioritize received emails by themselves at the receiving end even using messages sent between heterogeneous email systems. Of course, the ability to use message prioritizing must be preloaded in their email system. Once a user decides to reply back, the prioritizing flag is reset and the email is placed in date order like regular mails. Alternatively, the message may be kept in priority until they receive a confirmation from other party.

### Union of the Dual User Convenient Features

Users of the Time Scheduling Device, Method and System found herein may find features from the Message Prioritizing Device, Method and System useful in combination. Thus, another embodiment of the instant concepts specify using the Time Scheduling and Message Prioritizing concepts together. In this regard, outgoing emails arrive at the receiving end at the designated time and are listed in a high priority position at the receiving message queue. Also when using the Message Prioritizing method, users can specify what time and date the email system sends out originating emails, or sends replies back. At a receiving end, users can prioritize the incoming emails independently, and make replies scheduled to send out at the time and date they want to send it out.

### Expected Users of the Advanced Email Features

Therefore, these methods and system of Time Scheduling and Message Prioritizing can be implemented on all commercial Internet email system providers, including but not limited to Google, Yahoo, Hotmail, AOL; all mass-storage providing service companies; and also any local commercial email providers all over the world.

This method and system of Time Scheduling and Message Prioritizing are very useful for business transactions and for personal interests as well. Therefore, these can also be implemented on any Intranet email systems of federal, state and local government entities. Other users of the instant embodiments include but are not limited to: military forces, political parties, banks, financial institutions, stock exchanges, brokerage houses, public and private companies, schools, universities, educational institutions, hospitals, nursing homes, laboratories, restaurants, other food service businesses, non-profit organizations, associations, private clubs, closed user groups and all other entities utilizing Intranet email systems. Furthermore, this concept of Time Scheduling and Message Prioritizing is also useful for use in social networks, message transmitting systems on the web and mobile networks, and even computerized facsimile transmitting systems.

The preferred embodiments of the invention will hereinafter be described in conjunction with the appended drawings provided to illustrate and not to limit the invention, in which:

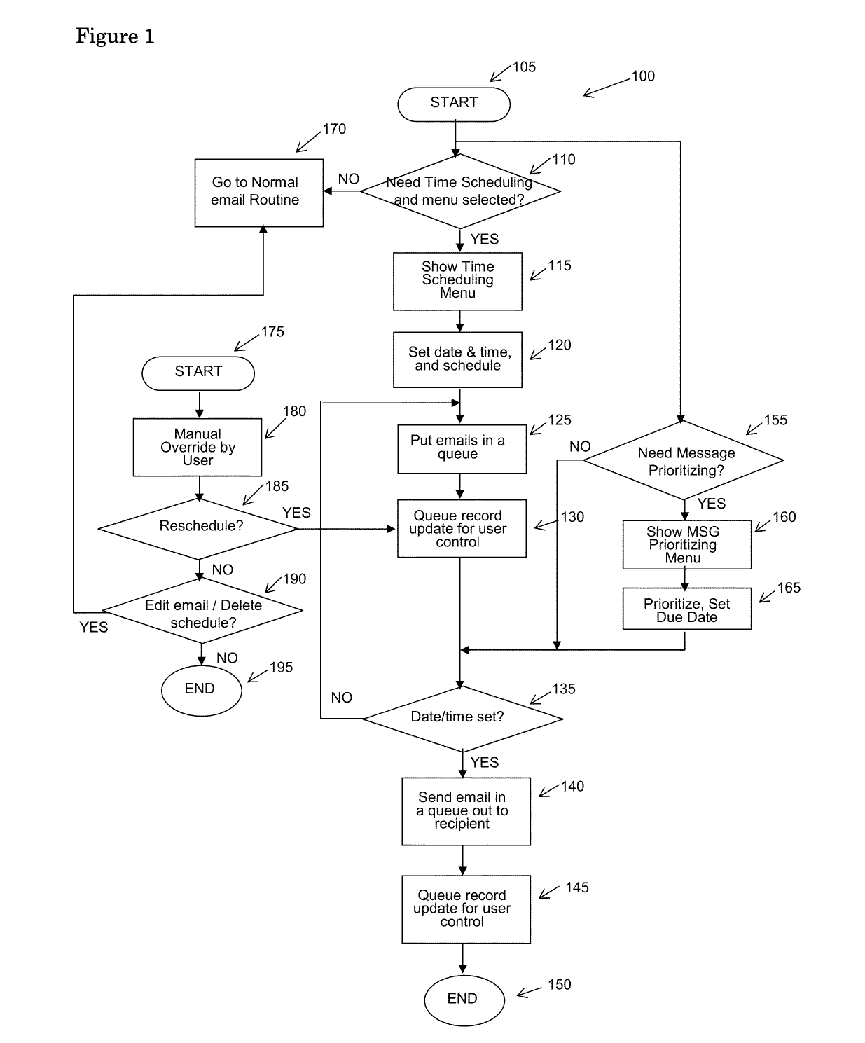

### FIG. 1: Time Scheduling Routine

FIG. 1 presents a flow diagram of Time Scheduling Routine 100 with various features that are to be discussed in an embodiment; this flow diagram also includes a simplified Message Prioritizing Routine that is combined and used with the Time Scheduling Routine 100 when it is operated as a mixed mode if it is selected by a user; this routine also includes a manual override operation by the user in order to reschedule and cancel the schedule. The present embodiment comprises two key user-convenient features including Time Scheduling that helps email senders to schedule the date and time when pre-written and queued originating emails/replies are actually mailed out to the recipient. Thus, the recipient can receive the email at the right time without the difficulty of finding an important email buried amongst other emails. Also, the software device herein described also has Message Prioritization that is also helpful to email senders in specifying message prioritizing while sending out their email to the recipient. In this fashion, the recipient can recognize what are prioritized emails that the recipient needs to reply to. A Message Prioritization method can be also usefully used independently at the receiving end by the recipients to mark emails as being prioritized by themselves and without the original sender's preference.

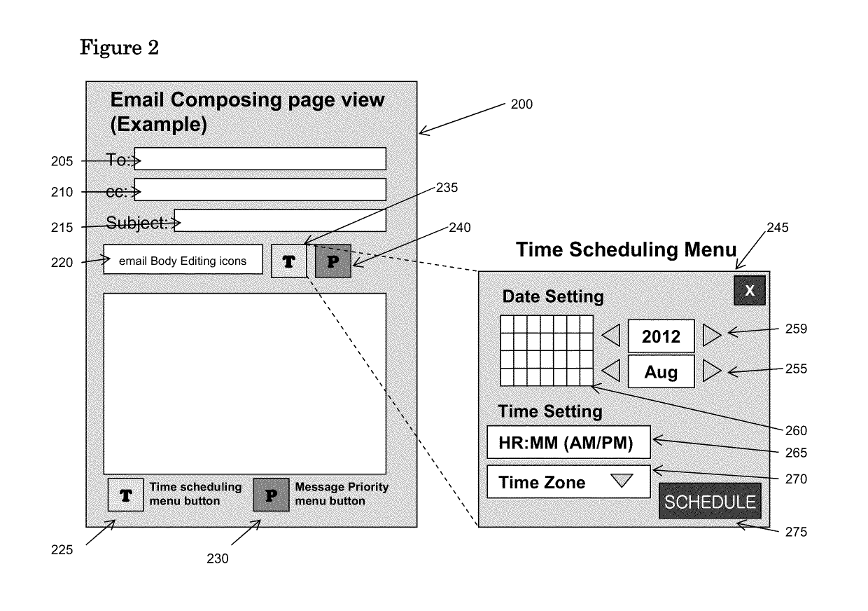

FIG. 1 illustrates how Time Scheduling Routine works in detail and how software programmers design and implement it accordingly. As in the ordinary email process a user accesses his or her email application on a PC, browser based email or mobile email application and receives a typical GUI email window as shown in FIG. 2, 200 and finally completes time scheduling by closing this menu box. The process starts 105 by a user deciding 110 upon whether or not to use a Time Scheduling routine available on an email GUI (graphical user interface) presented in FIG. 2 as button 235. If not being used then the routine proceeds to ordinary email operation 170. However, in the event a user of an originating email chooses to use the Time Scheduling Software device and method he or she clicks a button (shown in FIG. 2, 235) shown on the email composing page (FIG. 2, 200).

Then a Time Scheduling Routine displays 115 a time scheduling menu (FIG. 2, 245) in a subsequent operation comprising Date Setting (FIG. 2, 250, 255, 260) and Time Setting (FIG. 2, 265, 270) submenus. The user sets the date and time 120 and then clicks the SCHEDULE button (FIG. 2, 275) and then finally completes time scheduling by closing this scheduling menu box by the user (it should be appreciated that programmers can implement this procedure in a way that scheduling menu is automatically closed when just clicking SCHEDULE button by users and goes back to the email composing page for further instruction by users), the Time Scheduling is accomplished.

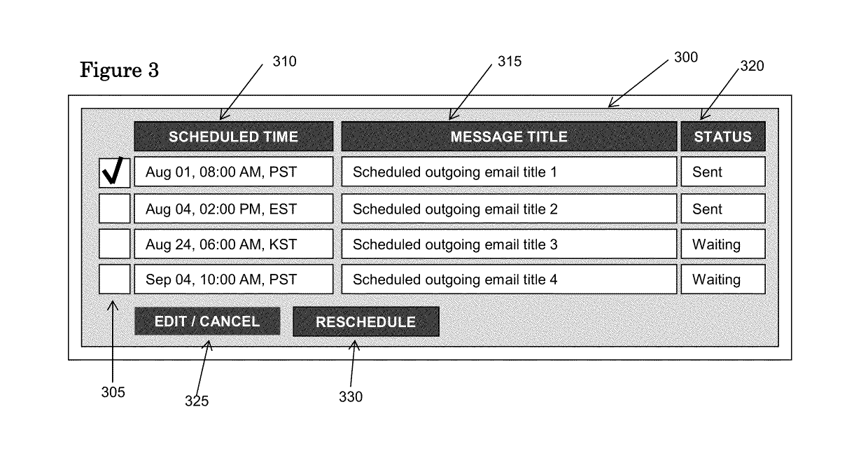

Then the Time Scheduling Routine puts the already written email including all title, recipients' email address, email body, and attachments if any into a queue 125, called the Time-scheduled Outgoing Email Queue that is a special queue designed to be used for this Time Scheduling purpose only. Then the routine updates the Record 130 of the queue shown on FIG. 3 (300). If pre-scheduled date and time are not set then the process cycles 125 through 135 are repeated until the set time. In the event that the date and time have been set to the preset time and date then the Time Scheduling Routine continues to send 140 out the queued email to the recipients at the user specified time and date. The queue status is displayed as a list (FIG. 3, 300) to a user and that is updated as to the status 320 of the sent message and this part of the process ends 150.

Another process is running concurrently with the aforementioned set of steps; this process starts 175 by user instruction from Record of Time-scheduled Outgoing Email Queue (FIG. 3, 300) and permits the email schedule record to be overridden by the user. In other words, the user can choose to manually override the message sending schedule 180. He or she then has the option of rescheduling the transmission of the email by changing the date and time when the email is actually going out 185. If the user wants to reschedule or change the time and date when the emails are actually sent out, then they click RESCHEDULE button (330) then Time Scheduling Menu (245) opens and then they can reschedule it. In other words, if the user wants to reschedule then he or she updates the already queued schedule from the record of the queue (FIG. 3, 300). If the user does not want to reschedule then the process proceeds to determine whether or not editing of the email or deleting of the schedule is desired. If the user does not want to edit the email nor delete the schedule then the process ends 195. However, in the event that the user wants to edit the email and or delete the schedule then the process proceeds to normal email functioning of step 170 and goes back to email composing page GUI (FIG. 2, 200).

In the manual override by the user, two menu buttons of EDIT/CANCEL 325 and RESCHEDULE 330 are prepared as shown on FIG. 3. Upon the selection of rescheduling of the date and time of the message transmission, the GUI time scheduling menu 245 opens up and is presented to the user for his input regarding date and time. When the time and/or date on the record are rescheduled by the user while selecting RESCHEDULE 330, the routine monitors newly set date and time to send out the email. When EDIT/CANCEL 325 on the record is selected by the user, the routine retrieves the queued email from the queue and returns to the normal email routine; in other words, the queued email pops up on the email composing page 200 as it queued for further operation by the user. Then the user can edit the email body, change recipients 205, 210, and schedule it again using the TIME SCHEDULING BUTTON 235, or just send it out immediately, or even delete/discard the email permanently. Programmers may program the routine to delete the prescheduled email from the record directly as an option. However, in this embodiment, the system gives the user one more last chance before deleting it permanently. That is why it is desirable to retrieve queued email and return it to the email composing page in order to protect that email from permanent deletion by the user's error.

Another process is running concurrently with the aforementioned set of steps in that a Message Priority Routine is operated if the user also selects 155 this method as shown on FIG. 1. A menu displaying Message Prioritization functions 160 along with permitting the user to set due date and time 165 (this is not the preset date and time to send out emails, but due date and time for an email originator, the first user wants to reply back from the second user) as to be discussed with the Message Prioritizing Routine described in detail later. The routine monitors and detects the date and time to send out, and then the routine sends out the email in the queue and updates Record of the queue and ends this Time Scheduling Routine. If none of either Time Scheduling or Message Prioritizing methods is selected, the email is treated as a normal email, and email system continues normal routines as programmed. Therefore, the email system just sends out the email without any scheduling and prioritizing functions.

FIG. 2: Email Composing GUI with Time Scheduling Menu

FIG. 2 presents a sample email composing page GUI with special menu buttons in this embodiment for a Time Scheduling menu popup that is activated to permit entry of user Time Scheduling information. The Email Composing GUI 200 of FIG. 2 comprises a To field 205, a cc field 210, a subject field 215, editing icons field 220, a bottom time scheduling menu button 225, a bottom message priority button 230, a top time scheduling menu button 235, a top message priority button 240, and a popup Time Scheduling Menu 245 includes a year arrow activated menu 250, a month arrow activated menu 255, a calendar 260, a time menu 265, a time zone menu 270 and a schedule button 275 to complete the task. It should be appreciated that either the top or bottom time scheduling or message priority buttons 235, 225, 240, 230 open up time scheduling and message prioritization menus. Further, when selecting a different time zone, the Time Scheduling Routine calculates the right time in that time zone to send out the email in their time. However, this date and time on this menu are synchronized by the system clock and then show the current date and time basically for convenience of the user.

### FIG. 3: Time Scheduling Outgoing Email Queue

FIG. 3 presents an embodiment of a GUI Time-scheduled Outgoing Email Queue 300 that lets the user know what scheduled message has been already sent, and what is still in the queue waiting for the date and time to be sent out. A check box 305 is provided at the extreme left of the queue record so that a user can choose to EDIT/CANCEL the checked message using a button 325 of the same name or RESCHEDULE the checked message using a button 330 of the same name. A list of scheduled times 310 for sending of the emails is provided in the next group of entries alongside the list 315 of message titles. At the extreme right of the GUI Time-scheduled Outgoing Email Queue 300 is a status list for the aforementioned messages of 315. In order to accomplish all of this the record is forcedly overridden by the user in case that the user wants to reschedule the date and time by clicking a RESCHEDULE button 330; and to edit the queued email, send the email without pre-scheduling, or delete the scheduled email from the queue permanently one must click the EDIT/CANCEL button 325. On the record, there is a check box 305 for each message line to select the message for rescheduling and editing/canceling functions as mentioned previously. By checking the check box 305 for that message for further manipulation and clicking RESCHEDULE button 330, a Time Scheduling routine pops up as a Time Scheduling Menu pops up as shown in FIG. 2, 245 again; thus, the user can reschedule the date and time. By clicking a Schedule button 275 on the menu and completing the rescheduling, the Time Scheduling Routine updates the record and monitors the new schedule. By checking the check box 305 and clicking EDIT/CANCEL button 325, the scheduled and queued message is not removed from the queue immediately, but the Time Scheduling Routine returns the queued email back to the email composing page 200 of the normal email routine for further operation by the user. From this email composing page 200, the user can edit the body of the email retrieved from the queue, change email recipients, and or even change title if needed, and then reschedule the email. Then the Time Scheduling Routine starts its operation again or the user can ignore pre-scheduled time and send the retrieved email right away without scheduling. From the email composing page 200, the user can delete/discard the message retrieved from the queues permanently. This sequence provides the user with one last chance to think it over whether they delete it for sure, and therefore eliminates any possible human error to delete the queued email from the Record of Time-scheduled Outgoing Queue unintentionally.

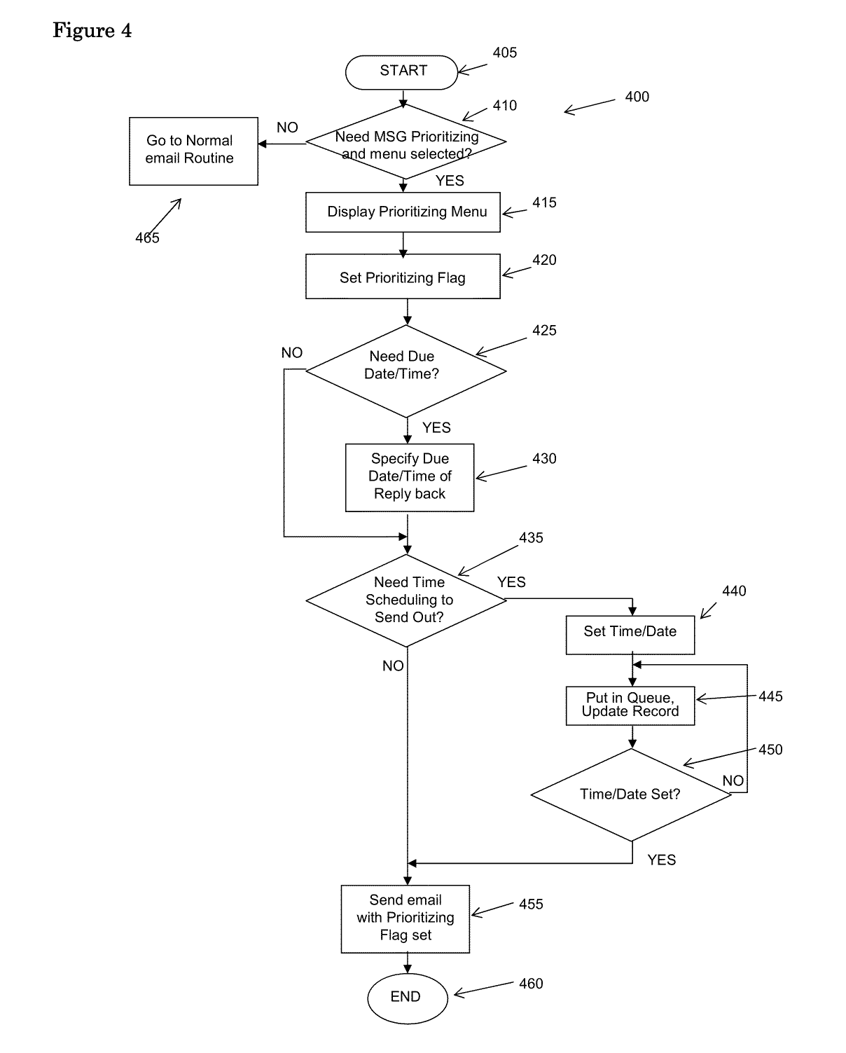

### FIG. 4: Message Prioritizing Routine

FIG. 4 presents an embodiment of a Message Prioritizing Routine 400 that also includes a simplified Time Scheduling Routine that is combined and used with the aforementioned Message Prioritizing Routine when it is operated in a mixed mode if selected by the user. FIG. 4 is Message Prioritizing Routine 400 at the originating end of an email message. This routine is activated by the email originator for a specific thread for the first time, or by the sender of a reply message on an incoming email. This routine contains two sub-functions, namely, one for setting a prioritization flag when selected, and the other for setting a due date that notifies and provides the recipient with a reply due date. Users have the choice of either just setting a priority flag, or the setting of the two sub-functions together at the same time. Programmers can also implement a confirmation requesting feature if necessary. In this feature, another bit is assigned to the email header for this purpose. Once a recipient receives the incoming email with this information being requested, then recipient sends a replying email back immediately.

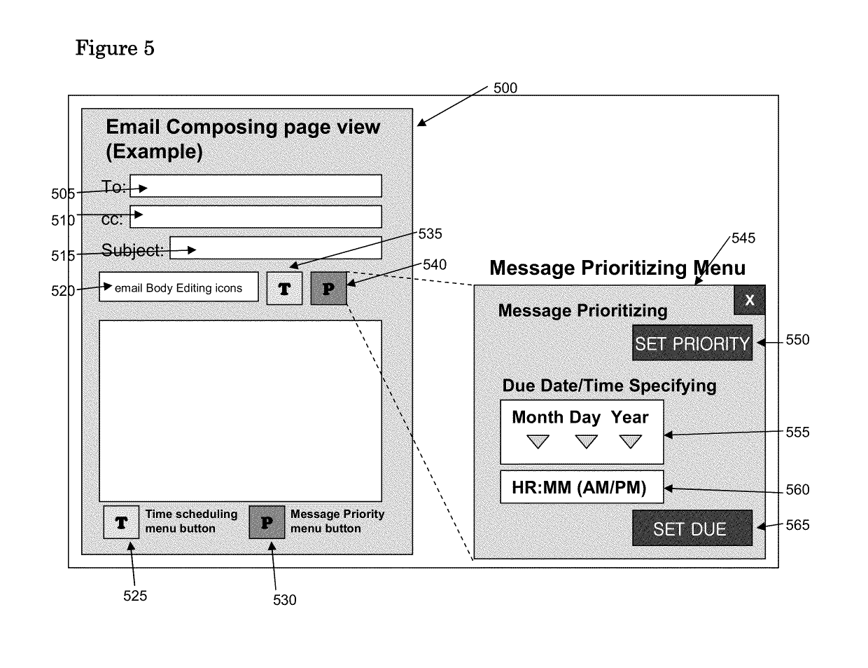

The process begins at step 405 by an email composing page shown in FIG. 5, 500 being displayed to a user having buttons for Time Scheduling 525, 535 and Message Prioritization 530, 540; then the first decision block 410 determines whether or not Message Prioritization is required. If not, then the normal routine 465 is booted up into the processing system of the computer. If Message Prioritization is required the Prioritization Menu is displayed 415 to a user including SET PRIORITY button 550 as well as SET DUE button 565 which further includes due date setting 555 and due time setting 560 as shown on FIG. 545; more generally, the date and time functions as shown in FIG. 5, 545 including Date 555 and Time 560 functions. As discussed previously, a prioritization flag is set 420 and then a decision block 425 determines whether or not a due date/time is required. If a due date/time is required then a user inputs 430 due date and or time using the Message Prioritization Menu 545 of FIG. 5 that has a date function 555 and a time function 560 that are controllable using simple arrow graphical controls and text entry respectively. To set the due date and time a SET DUE button 565 is pressed by the user to indicate to the computer system the required due date and time. Then the routine proceeds forward to decision block 435. Similarly, if no due date/time is required the process skips down to decision block 435 that is time scheduling of the email to send out in a specified time and date. Similarly, if no time and date is set to schedule the process skips down to decision block 455.

At this point the process makes a determination as to whether or not the user would like to schedule a time to send out the message. If time scheduling is required then the process proceeds to opening up a graphical user interface GUI for user review such as that found in FIG. 2, 245; there the time and date are set 440 by a user entering the information into the popup menu described previously. Then the routine places the date and time as well as message information into a queue and updates the queue record 445 displayed as in FIG. 4. If the time and date were not set to the preset time then the process cycles back to placing the item back into the queue 445. Once the time and date were set to the preset time then the process proceeds to sending 455 the email to the recipient with the prioritization email flag set. If time scheduling is not required then the process proceeds to sending 455 the email to the recipient only with the prioritization email flag set. In either branch the process stops at step 460.

FIG. 5: Email Composing GUI with Message Prioritization Menu

FIG. 5 presents a sample email composing page GUI with special menu buttons in this embodiment for a Message Prioritizing menu popup that is activated to permit entry of user Message Prioritizing information. Most generally, from the Due Date/Time Specifying submenu, the user can specify detailed due date and time exactly. By clicking triangular icons under the fields representing month, day and year, the user can the select month, day and year that the email is due. In the same fashion, the user can specify an exact time the email is due. Time, however, is preset to 00:00 AM midnight local time. Therefore, if the user does not specify an exact time, but specifies just a certain day, then the time the email is due is preset to midnight of the selected day. The date selection menu may be implemented in the same calendar view manner that was described in Time Scheduling above. Similarly, the time zone is implemented in the same way as it was in Time Scheduling above, if needed. More particularly, the Email Composing GUI 500 of FIG. 5 comprises a To field 505, a cc field 510, a subject field 515, editing icons field 520, a bottom time scheduling menu button 525, a bottom message priority button 530, a top time scheduling menu button 535, a top message priority button 540, and a popup Message Prioritizing Menu 545 includes a SET PRIORITY button 550, a month, date and year arrow activated menu 555, a time text entry menu 560, and a SET DUE button 565. It should be appreciated that either the top or bottom time scheduling or message priority buttons 535, 525, 540, 530 open up time scheduling and message prioritization menus.

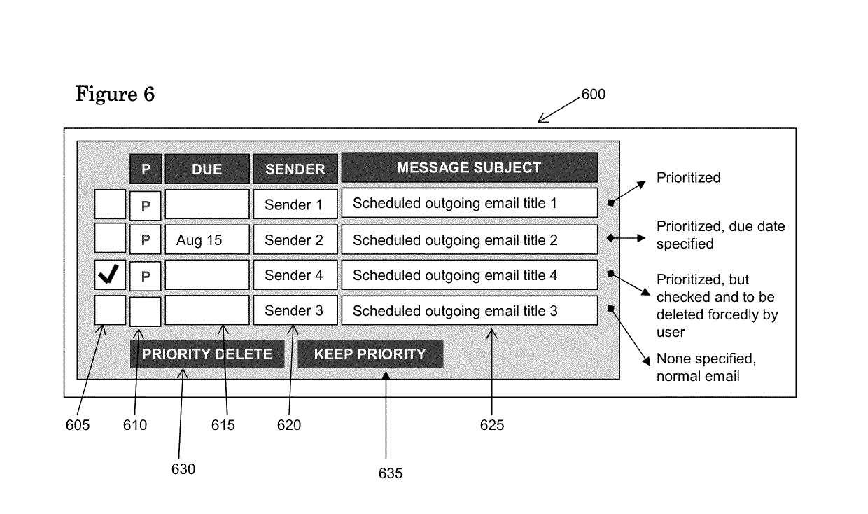

### FIG. 6: Recipient Incoming Email Box

FIG. 6 presents an embodiment of a GUI Recipient Incoming Email Box 600 from which the user can recognize which incoming emails are important emails and/or when is the due date/time that were marked by the sender as being prioritized in field 610 and/or the due-dated in field 615. The sender 620 and the message subject 625 are likewise included in the incoming popup box 600. A check box 605 is provided at the extreme left of the queue record so that a user can choose to DELETE PRIORITY using a button 630 of the same name or KEEP PRIORITY using a button 635 of the same name. More generally, among the prioritized messages, messages are basically organized in the order of time when a given message is received; in other words, the prioritized message that is received last is placed at the very top. However, this order can be overridden by the user by simply clicking the priority status display (“bold letter P” shown in FIG. 6) that causes the clicked message to be placed at the very top of the queue. In this manner, the most important message is placed at the very top with the hope that it can grab the user's attention. Finally, prioritized incoming emails can be either placed on the top portion of the incoming mail box along with normal emails underneath, or placed in a separate priority email box that is a dedicated priority email box that is kept separated from the normal emails. Programmers can implement placement of the prioritized messages in either way. However, it is better to be researched before implementing in which way users feel convenience.

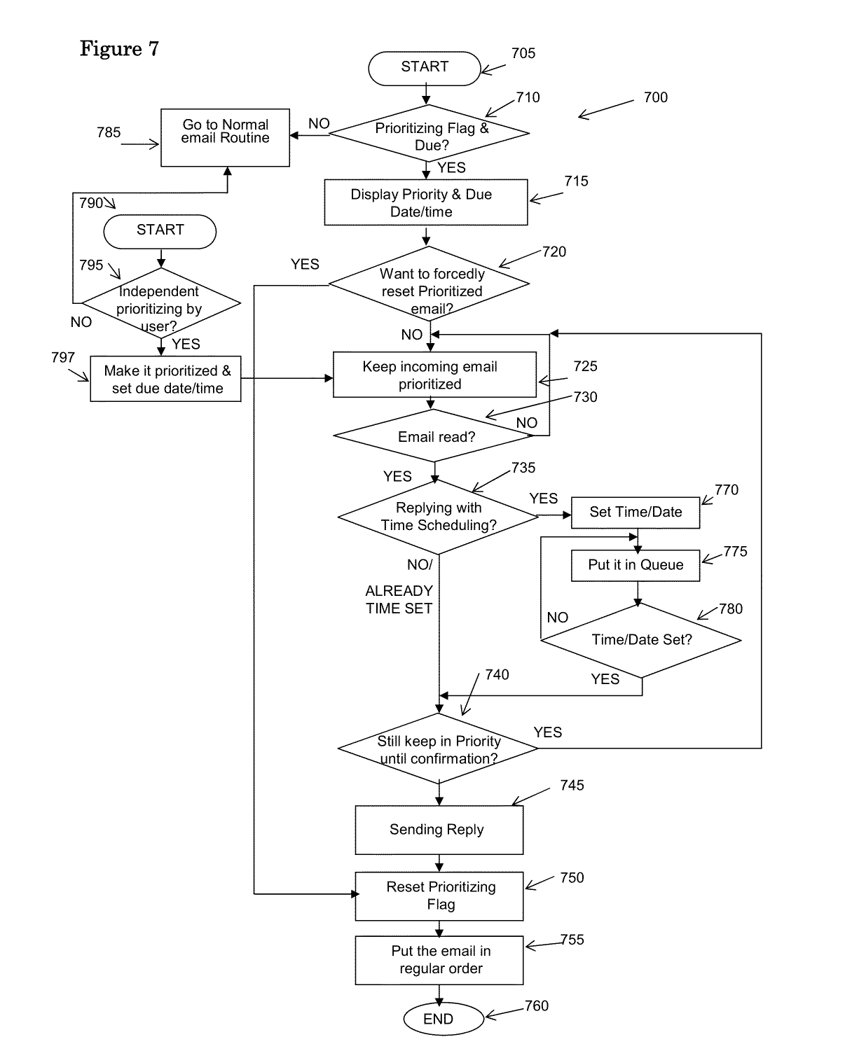

### FIG. 7: Recipient Message Prioritizing Routine

FIG. 7 presents a flow diagram of Message Prioritizing Routine at the receiving end; this flow diagram also includes a simplified Time Scheduling Routine that is combined and used with Message Prioritizing Routine when it is operated as a mixed mode if it is selected by a user.

FIG. 7 illustrates Message Prioritizing Routine at the Recipient's 700 location. The process starts at block 705 and proceeds to determine 710 whether or not an incoming email has the prioritizing flag set and whether or not a due date and time are specified. If these are not present then the normal email routine is started 785. If an incoming message has the priority set, then Message Prioritizing Routine places the message (FIG. 6, 600) on the top of the incoming box with a clear marker 715 that highlights the email; for example, the message is flagged with a display of a ‘bold letter in red’ next to the email message (FIG. 6, 610). If an incoming message has due date (or even due time) specified, then Message Prioritizing Routine also displays the due date and time as well next to the email message (FIG. 6, 615).

When the user decides to un-prioritize the incoming email by checking the check box and clicking PRIORITY DELETE (FIG. 6, 630) button, then Message Prioritizing Routine resets the prioritizing flag 750 and treats that email as a normal email and places 755 it in a normal order. If PRIORITY DELETE (FIG. 6, 630) is not selected, then the routine keeps 725 that email prioritized until that email is read and replied back. A decision is made as to whether or not the email was read; if the email has not been read by the user then the process cycles back to keeping the email prioritized 725 and the decision 730 is repeated. If the email has been read then another decision block determines whether or not TIME SCHEDULING 735 applies in this instance.

As a Time Scheduling Routine is operably combined with Message Prioritizing routine, likewise a Message Prioritizing routine at the receiving end is also operable while Time Scheduling is set. Therefore the next procedure is a determination 735 as to whether or not time scheduling is desired for the reply message. If the user decides to select Time Scheduling when replying to the prioritized email, then the routine goes to this Time Scheduling Routine; the user set date and time 770, the Time Scheduling Routine puts the email into a queue 775 and waits for the pre-set date and time 780. If current time and date is not met to the preset date and time at this point the process cycles back to placing the email in a queue until the pre-set time is met for that email 775. If the date and time is set with the preset date and time, then the routine goes back to the main Message Priority Routine and makes the replying email ready to send out. If the user declines Time Scheduling, then Message Prioritizing Routine makes the replying email directly ready to send out.

Before sending out the replying email, the Message Priority Routine at the receiving end finally checks 740 whether the user wants to still keep the incoming email prioritized until the reply is confirmed by the other party, or un-prioritize it. If the user selected to keep prioritized, then the routine keeps the reply along with the same thread of the incoming messages on the prioritized 725 portion of the mail box and sends out the reply 745. If the user unselect keeping prioritized, then the routine sends out the reply 745 and at the same time resets the prioritizing flag 750 and places the reply as well as incoming messages in normal order 755. Now message prioritizing routine at the receiving end is completed 760.

When the users reply emails back for the incoming emails that were not marked as the prioritized when received, then they can also set the reply email prioritized. Then Message Prioritizing Routine is performed once again at the receiving end, however this time the receiving end works like the originating end. However, when users keep emails prioritized and reply back, in other words, if incoming email still keeps prioritizing status, then the replying email under the same thread is sent out with prioritized status, even though the user does not set the replying email prioritized once again.

FIG. 7 also includes a method to make an incoming email prioritized by the recipient. This operation is done independently, no matter how the originating end has prioritized a message or not; in order words, even though the incoming message was not prioritized the recipient can mark it as such. Thus, the process starts 790 by determining if a recipient regards 795 that an incoming email is very important. If it is then it requires extra attention such that the recipient marks the email as being prioritized 797 and the process proceeds to block 725 where the ordinary incoming recipient prioritization routine continues. In order to mark it, the message can be prioritized by checking the check box in the incoming email box (as in FIG. 6) and clicking KEEP PRIORITY button 635. Then the Message Priority Routine sets the priority flag on the mail header treating this manually set email as the prioritized one just like the incoming email with the priority flag is already set. If the incoming message is not to be independently marked as prioritized then the normal email routine is invoked at step 785.

The embodiments taught herein are described for any type of processing architecture or environment that uses email or upon which email is transmitted; thus, for the purposes of this disclosure, a general mechanism called a COMPUTER DEVICE is hereafter defined as meaning a device that includes but is not limited to: a smart phone application processor, a processor, a multiprocessor, a computer readable medium, network circuits, internet, computer networks, LAN, WAN, telecommunications, mobile phone devices, smart devices, PDA, portable computer, standalone computer, terminal station, mobile devices. Further the term ‘computer program product’ is defined as instructions that are stored on RAM, ROM, nonvolatile memory, volatile memory, EPROM, memory devices, static RAM, flash RAM, compact disk, DVD, Blue RAY, local computer registers or a generic memory device. Thus, the word ‘computer device,’ and similar terminology should be given their broadest possible interpretation meaning a processing system and or device that has email capability. Finally, it should be understood that the routines and processes described herein comprise a group or set of software instructions or a ‘Computer Program Product’ that is executed on the above defined ‘Computer Devices.’ The instant invention has been shown and described herein in what is considered to be the most practical and preferred embodiment. It is recognized, however, that departures may be made therefrom within the scope of the invention and that numerous modifications may be made that would be within the bounds defined by the following claims.

What is claimed is:

1. A method of time scheduling email messages on a computer device comprising the steps of:
starting an email program having an email composing page and
presenting a user with a graphical user interface having an email time scheduling option associated with the email composing page.

2. The method of time scheduling email messages on a computer device of claim 1, further comprising the steps of:
opening a time scheduling menu for user interaction.

3. The method of time scheduling email messages on a computer device of claim 2, further comprising the steps of:
receiving user response indicating user selected preferences of the time scheduling menu.

4. The method of time scheduling email messages on a computer device of claim 3, wherein the time scheduling menu has user interactive graphic selection items chosen from the group comprising: year, month, date, hour, minute, time zone and all combinations of the foregoing.

5. The method of time scheduling email messages on a computer device of claim 3, further comprising the steps of:
placing emails in a queue for time and or date based transmission.

6. The method of time scheduling email messages on a computer device of claim 5, further comprising the steps of:
creating a queue record of emails that have been queued.

7. The method of time scheduling email messages on a computer device of claim 6, further comprising the steps of:
displaying a graphic representative of the queue record to the user.

8. The method of time scheduling email messages on a computer device of claim 7, wherein the graphic representative of the queue record has graphical items chosen from the group comprising: scheduled time, message title, status, checkbox, edit/cancel graphic, reschedule interactive graphic and all combinations of the foregoing.

9. The method of time scheduling email messages on a computer device of claim 7, further comprising the steps of:
transmitting a queued email message to another user via a network.

10. A method of prioritizing email messages on a computer device comprising the steps of:
starting an email program having an email composing page and
presenting a first user with a graphical user interface having an email message prioritization option associated with the email composing page.

11. The method of prioritizing email messages on a computer device of claim 10, further comprising the steps of:
opening a message prioritizing menu for user interaction.

12. The method of prioritizing email messages on a computer device of claim 11, further comprising the steps of:
receiving the first user's response indicating the first user's selected preferences of the message prioritizing menu.

13. The method of prioritizing email messages on a computer device of claim 12, wherein the message prioritizing menu has user interactive graphic selection items chosen from the group comprising: due year, due month, due day, due hour, due minute, set priority graphic, set due graphic and all combinations of the foregoing.

14. The method of prioritizing email messages on a computer device of claim 12, further comprising the steps of:
transmitting an email message with visual attention to a second user via a network.

15. The method of prioritizing email messages on a computer device of claim 14, further comprising the steps of:
displaying a prioritized incoming email message in a separate area of an incoming box at the second user's computer.

16. The method of prioritizing email messages on a computer device of claim 15, wherein the incoming email message box has graphical items chosen from the group comprising: checkbox, priority flag, due date, sender, message subject, priority delete graphic, keep priority graphic and all combinations of the foregoing.

17. The method of prioritizing email messages on a computer device of claim 15, further comprising the steps of:
checking a prioritizing flag and if set then the incoming message is prioritized so
displaying a prioritized incoming email message in a priority box at the second user's computer otherwise go to a normal email routine.

18. The method of prioritizing email messages on a computer device of claim 17, further comprising the steps of:
determining if the second user wants to reset the prioritizing flag and if not then the email message is kept as prioritize otherwise the prioritizing flag is reset and the email message is placed in an ordinary place in the incoming email box.

19. The method of prioritizing email messages on a computer device of claim 18, further comprising the steps of:
transmitting a reply from the second user across a network to the first user after the second user has interacted with the incoming email box to create a reply to the first user and
placing the email message in an ordinary place in the incoming email box.

20. A method of mixed mode of time scheduling and message prioritization of email messages on a computer device comprising the steps of:
starting an email program having an email composing page and
presenting a user with a graphical user interface having an email time scheduling optional graphical interactive and an email prioritization optional graphical interactive associated with the email composing page.
